(19) United States
(12) Patent Application Publication
(10) Pub. No.: US 2013/0121126 A1
(43) Pub. Date: May 16, 2013

(54) OPTICAL ELEMENT HOLDER, OPTICAL ELEMENT UNIT, AND OPTICAL PICKUP APPARATUS

(71) Applicant: Yasufumi YAMAGISHI, Kumagaya-shi (JP)

(72) Inventor: Yasufumi YAMAGISHI, Kumagaya-shi (JP)

(73) Assignees: Sanyo Optec Design Co., Ltd., Ora-gun (JP); Sanyo Electric Co., Ltd., Moriguchi-shi (JP)

(21) Appl. No.: 13/593,152

(22) Filed: Aug. 23, 2012

Related U.S. Application Data
(63) Continuation of application No. PCT/JP2011/078469, filed on Dec. 8, 2011.

(30) Foreign Application Priority Data
Nov. 16, 2011 (JP) 2011-251134

(51) Int. Cl. G02B 5/18; G11B 7/135

(52) U.S. Cl. 369/112.01; 359/566; G9B/7.112

(57) ABSTRACT

A holder has walls defining a holding region for holding an optical element, and has a protrusion part overlapping the holding region. The protrusion part is formed at a deformable support part, and can be displaced in a direction away from the holding region by deformation of the support part. When the optical element is fitted into the holding region, the support part deforms and the protrusion part runs on a side surface of the optical element. In this state, the optical element is pressed until a back surface of the optical element abuts a support surface of the holder. The optical element is pressed against the wall and positioned by a return force of the support part.

This application claims priority under 35 U.S.C. Section 119 of Japanese Patent Application No. 2011-251134 filed Nov. 11, 2011, entitled “OPTICAL ELEMENT HOLDER, OPTICAL ELEMENT UNIT, AND OPTICAL PICKUP APPARATUS”. The disclosure of the above application is incorporated herein by reference.

### BACKGROUND OF THE INVENTION

1. Field of the Invention

The present invention relates to an optical element holder, an optical element unit with an optical element attached to the holder, and an optical pickup apparatus including the optical element unit.

2. Disclosure of Related Art

Conventionally, an optical pickup apparatus includes various optical elements such as a diffraction grating and a half mirror. These optical elements need to be accurately mounted on a housing of the optical pickup apparatus. In this case, a predetermined optical element, in a state of being attached to a holder, is mounted on the housing. For example, if a rectangular diffraction grating is to be mounted on the housing, the diffraction grating is attached to the holder, and then the holder is mounted on the housing.

If an optical element is to be mounted on a housing using a holder as described above, it is first desired that the optical element can be attached to the holder in an easy and accurate manner. In addition, it is also desired that the holder can be mounted on the housing in an easy and accurate manner.

### SUMMARY OF THE INVENTION

A first aspect of the present invention relates to a holder for holding an optical element and mounting the same to a placement member. In the first aspect, the holder is made of a flexible material. The holder has in an integrated manner: a wall surface that defines a contour of a region in which the optical element is fitted with a predetermined gap; a protrusion part that protrudes in a direction perpendicular to the wall surface and is formed at a support part so as to be deformable in a direction away from the region; and a support surface that, when the optical element is fitted in the region, abuts a side surface of the optical element in a fitting direction. The protrusion part is formed such that, when the optical element is fitted in the region while the side surface of the optical element abuts the wall surface opposed to the protrusion part, a leading end of the protrusion part abuts an end edge of the optical element. In the state in which the leading end of the protrusion part abuts the end edge of the optical element, when the optical element is further pressed in the fitting direction, the support part elastically deforms, and the protrusion part abuts the side surface of the optical element beyond the end edge of the optical element, and the side surface of the optical element in the fitting direction abuts the support surface, and then the optical element is pressed against the wall surfaces by an elastic return force of the support part.

A second aspect of the present invention relates to an optical element unit in which an optical element and a holder thereof are integrated. The optical element unit according to the second aspect includes the optical element holder according to the first aspect and an optical element attached to the holder.

A third aspect of the present invention relates to an optical pickup apparatus. The optical pickup apparatus according to the third aspect includes an optical system for radiating laser light emitted from a laser light source to a disc; a housing as the placement member on which the optical system is placed; a holder mounted on the housing in a state of holding a predetermined optical element constituting the optical system. In this arrangement, the holder has the configuration according to the first aspect.

A fourth aspect of the present invention relates to a holder for holding an optical element and mounting the same to the placement member. In the fourth aspect, the holder is made of a flexible material, and the holder has in an integrated manner: a holding part holding the optical element; a plate-like flexible part made flexible by separated with space; and a protrusion part that is formed on one surface of the flexible part and abuts an abutment surface of the placement member when the holder is mounted on the placement member. When the holder is placed on the placement member, the protrusion part abuts the abutment surface to elastically deform the flexible part, and a side surface of the holder is pressed against the holding part of the placement member by an elastic return force of the deformed flexible part.

### BRIEF DESCRIPTION OF THE DRAWINGS

The foregoing and other objectives and novel features of the present invention will be more fully understood from the following description of preferred embodiments when reference is made to the accompanying drawings.

FIGS. 1A and 1B are each diagrams showing an optical system in an optical pickup apparatus according to an embodiment of the present invention; and FIG. 1C is a diagram showing a configuration of a semiconductor laser according to the embodiment;

FIG. 2 is a diagram showing a configuration of the optical pickup apparatus according to the embodiment;

FIG. 3 is a diagram showing a configuration of the optical pickup apparatus according to the embodiment;

FIG. 4 is a diagram showing a configuration of a holder according to the embodiment;

FIG. 5 is a diagram showing a configuration of the holder according to the embodiment;

FIGS. 6A and 6B are diagrams each showing a configuration of the holder according to the embodiment;

FIGS. 7A to 7C are diagrams each for describing a process of attachment of a diffraction grating to the holder according to the embodiment;

FIGS. 8A to 8D are diagrams each for describing operations of a hole and a groove according to the embodiment;

FIGS. 9A and 9B are diagrams each for describing a process of mounting of the holder to the housing according to the embodiment;

FIGS. 10A and 10B are diagrams each for describing a process of mounting of the holder to the housing according to the embodiment;

FIG. 11 is a diagram showing a configuration of a holder according to a modification example of the embodiment; and

FIGS. 12A and 12B are diagrams each showing operations of the holder according to the modification example; and FIGS. 12C and 12D are diagrams each showing operations of the holder according to the embodiment.

However, the drawings are only for illustration and are not intended to limit the scope of the present invention.

### DESCRIPTION OF PREFERRED EMBODIMENTS

An embodiment is an optical pickup apparatus irradiating laser light to Blu-ray discs (BDs), compact discs (CDs), and digital versatile discs (DVDs) to which the present invention is applied.

In the embodiment, a diffraction grating 102 is equivalent to an “optical element” recited in the claims. A diffraction grating holder H is equivalent to a “holder” recited in the claims. A wall H11a is equivalent to a “wall surface or a third wall surface” recited in the claims. A wall H11b is equivalent to a “wall surface or a fourth wall surface” recited in the claims. A wall H11c is equivalent to a “wall surface” recited in the claims. A wall H11d is equivalent to a “second wall surface” recited in the claims. A wall H11e is equivalent to a “third wall surface” recited in the claims. A groove H18 is equivalent to a “groove part” recited in the claims. A flange part H13 is equivalent to a “support part” recited in the claims. A concave part H20 is equivalent to an “escape part” recited in the claims. Bridge parts H23 and H24 are equivalent to a “flexible part or a thin-walled part” recited in the claims. A support part H35 is equivalent to a “support shaft part” recited in the claims. A support surface M11 is equivalent to a “holding part” recited in the claims. However, the foregoing correspondence between the claims and the description of the embodiment is merely one example, and does not limit the claims to the embodiment.

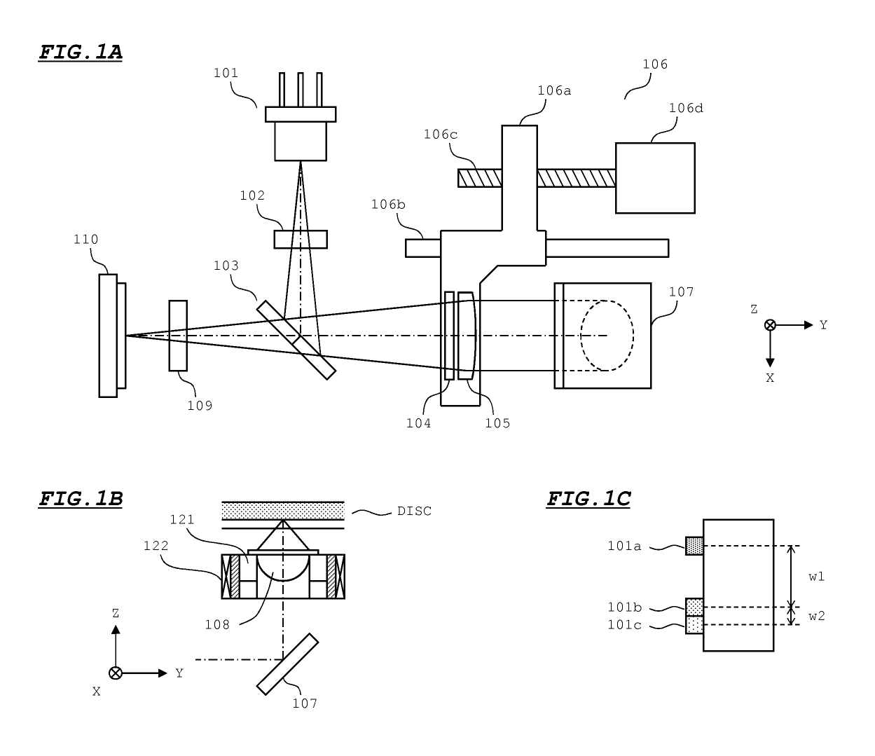

FIGS. 1A and 1B show an optical system in an optical pickup apparatus according to the embodiment. FIG. 1A is a top view of the optical system, FIG. 1B is an internal perpendicular view of an object lens actuator and a peripheral part thereof as seen from a side surface, and FIG. 1C is a diagram showing layout of laser elements in a semiconductor laser 101.

Referring to FIG. 1A, the optical pickup apparatus includes: the semiconductor laser 101; a diffraction grating 102; a flat plate-shaped polarization beam splitter (PBS) 103; a λ/4 plate 104; a collimator lens 105; a lens actuator 106; a rising mirror 107; an object lens 108; a diffraction optical element 109; and an optical detector 110.

The semiconductor laser 101 emits laser light with a wavelength of about 400 nm (hereinafter, referred to as “BD light”), laser light with a wavelength of about 650 nm (hereinafter, referred to as “DVD light”) , and laser light with a wavelength of about 780 nm (hereinafter, referred to as “CD light”), in the same direction.

As shown in FIG. 1C, the semiconductor laser 101 includes in one CAN, laser elements 101a, 101b, and 101c emitting BD light, DVD light, and CD light, respectively. The laser elements 101b and 101c are integrally formed such that a gap between luminous points thereof becomes w2. The laser element 101a is formed such that a gap between a luminous point thereof and the luminous point of the laser element 101b becomes w1 (w1>w2). The laser elements 101a, 101b, and 101c are formed such that the luminous points thereof are aligned in a straight line. Optical system subsequent to the semiconductor laser 101 is adjusted such that an optical axis thereof matches an optical axis of DVD light.

Of BD light, DVD light, and CD light emitted from the semiconductor laser 101, the diffraction grating 102 divides only the BD light into a main beam and two sub-beams. The DVD light and CD light are also subjected to diffracting function of the diffraction grating 102, but sub-beams of these lights are extremely small in strength. The diffraction grating 102 is a plate-like optical element with a parallelogram contour as seen in the direction of an optical axis.

The PBS 103 reflects laser light entered from the diffraction grating 102 side. The PBS 103 is a thin parallel plate and has a polarizer film on an incident surface thereof. The semiconductor laser 101 is placed such that a direction of polarization of BD light, DVD light, and CD light is S-polarized with respect to the PBS 103.

The λ/4 plate 104 converts the laser light reflected by the PBS 103 into circular polarized light, and converts reflected light from a disc into linear polarized light orthogonal to the direction of polarization at traveling toward the disc. Accordingly, the laser light reflected by the disc passes through the PBS 103 and is guided to the optical detector 110.

The collimator lens 105 converts the laser light reflected by the PBS 103 into parallel light . The lens actuator 106 drives the λ/4 plate 104 and the collimator lens 105 in the direction of optical axis of the collimator lens 105.

The lens actuator 106 includes a movable member 106a, a shaft 106b, a gear 106c, and a motor 106d. The movable member 106a holds the λ/4 plate 104 and the collimator lens 105. The movable member 106a is supported by the shaft 106b so as to be movable in the direction of optical axis of the collimator lens 105. In addition, the lens actuator 106 includes a gear (not shown) with which the gear 106c engages. The gear 106c is coupled to a drive shaft of the motor 106d. When the motor 106d is driven, the collimator lens 105 held by the movable member 106a moves together with the λ/4 plate 104. Accordingly, the collimator lens 105 moves in accordance with a control signal, thereby to correct aberration generated in laser light.

The rising mirror 107 reflects the laser light entered via the collimator lens 105 in a direction toward the object lens 108. The object lens 108 is held by an object lens holder 121, and the object lens holder 121 is driven by an object lens actuator 122 in a focus direction and a tracking direction. As in the foregoing, when the object lens holder 121 is driven, the object lens 108 is also driven in the focus direction and the tracking direction.

The reflected light from the disc is converted by the λ/4 plate 104 into linear polarized light that is P-polarized with respect to the PBS 103. Accordingly, the reflected light from the disc passes through the PBS 103. The PBS 103 is inclined at an angle of 45 degrees with respect to the optical axes of BD light, DVD light, and CD light. Therefore, when BD light, DVD light, and CD light pass in a convergent state through the PBS 103, astigmatism is introduced into these lights.

The diffraction optical element 109 diffracts BD light, DVD light, and CD light. The diffraction optical element 109 is designed so as to have a high +1-order diffraction efficiency for BD light and have a high 0-order diffraction efficiency for DVD light and CD light. The diffraction optical element 109 inflects a +1-order diffraction ray of BD light in a direction toward the optical axis of DVD light, and radiates the same to an irradiation position of DVD light on a light-receiving surface of the optical detector 110.

The optical detector 110 has four-divided sensors at positions to be irradiated with the 0-order diffraction rays of DVD light and CD light. The diffraction optical element 109 diffracts a main beam (+1-order diffraction ray) of BD light as described above, and radiates the same to the four-divided sensor receiving DVD light. Further, the optical detector 110 has four-divided sensors at positions to be irradiated with two sub-beams (+1-order diffraction rays) of BD light. The optical detector 110 has a sensor layout set so as to generate a reproduction RF signal, a focus error signal, and a tracking error signal according to outputs from the sensors.

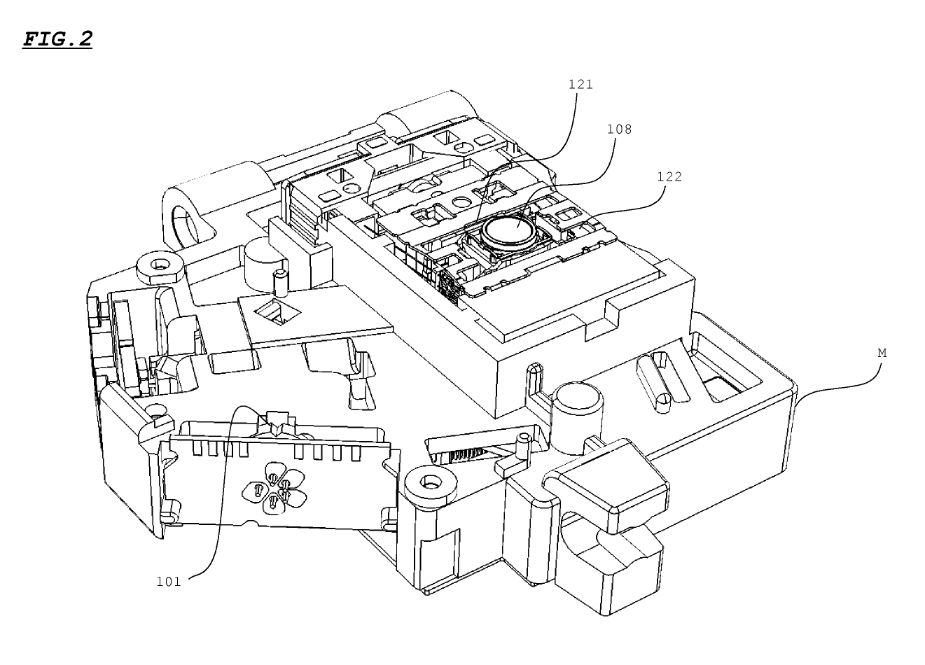

FIG. 2 is a perpendicular view of the optical pickup apparatus as seen from the beam outputting side. Of the components shown in FIGS. 1A and 1B, FIG. 2 shows the object lens 108, the object lens holder 121, and the object lens actuator 122. The other optical systems are attached to a back side of a housing M. The housing M is made of polyphenylene sulfite (PPS).

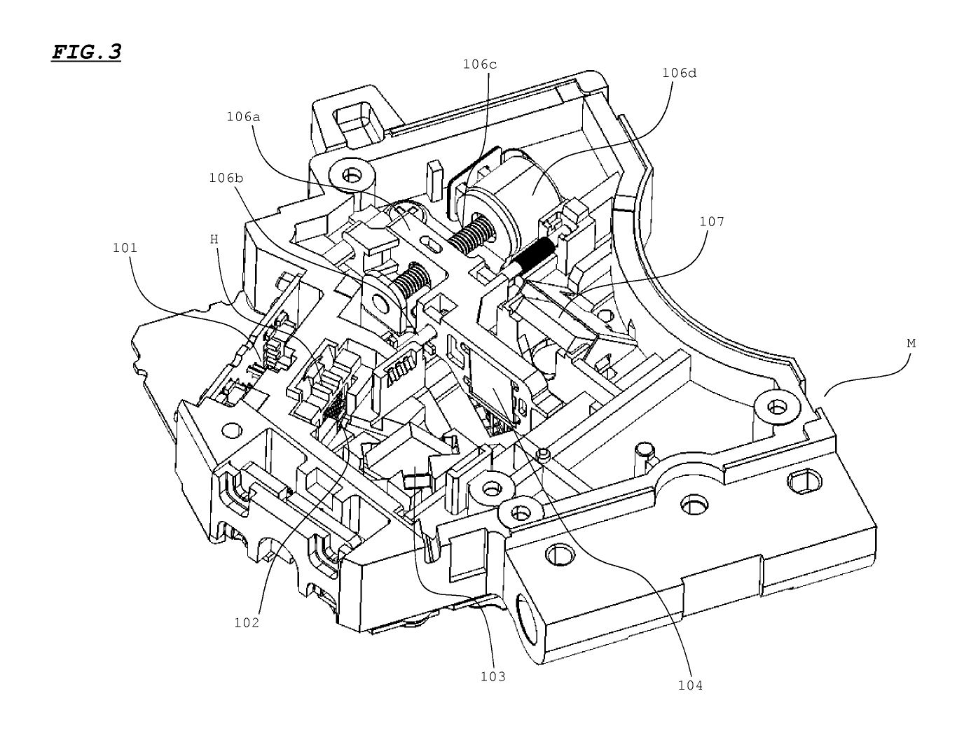

FIG. 3 is a perpendicular view of the optical pickup apparatus as seen from the back side. Of the components shown in FIGS. 1A and 1B, FIG. 3 shows the semiconductor laser 101, the diffraction grating 102, the PBS 103, the λ/4 plate 104, the movable member 106a, the shaft 106b, the gear 106c, the motor 106d, and the rising mirror 107.

As shown in FIG. 3, the housing M has a bottomed box shape with side walls therearound. That is, the housing M has on the back side thereof a concave part surrounded by the side walls. The concave part is provided with walls defining regions in the concave part to form reception parts for placement of individual members of the optical system. The individual members of the optical system are placed in the corresponding reception parts, directly or in a state of being housed in the holder. The diffraction grating 102 is attached to the housing M in a state of being housed in the diffraction grating holder H.

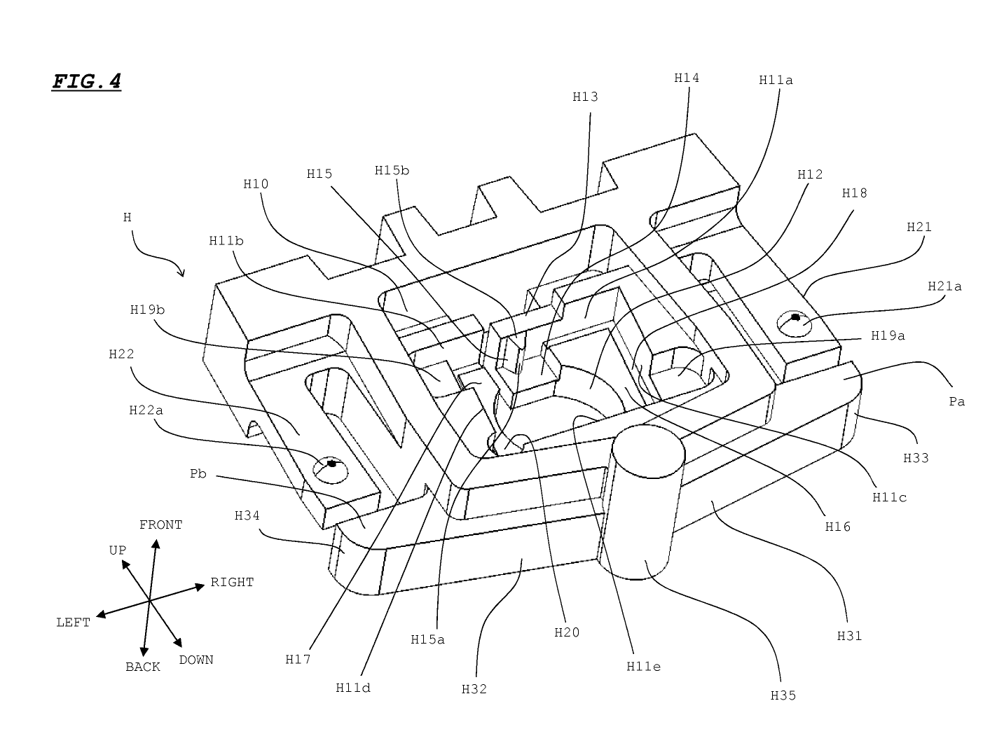

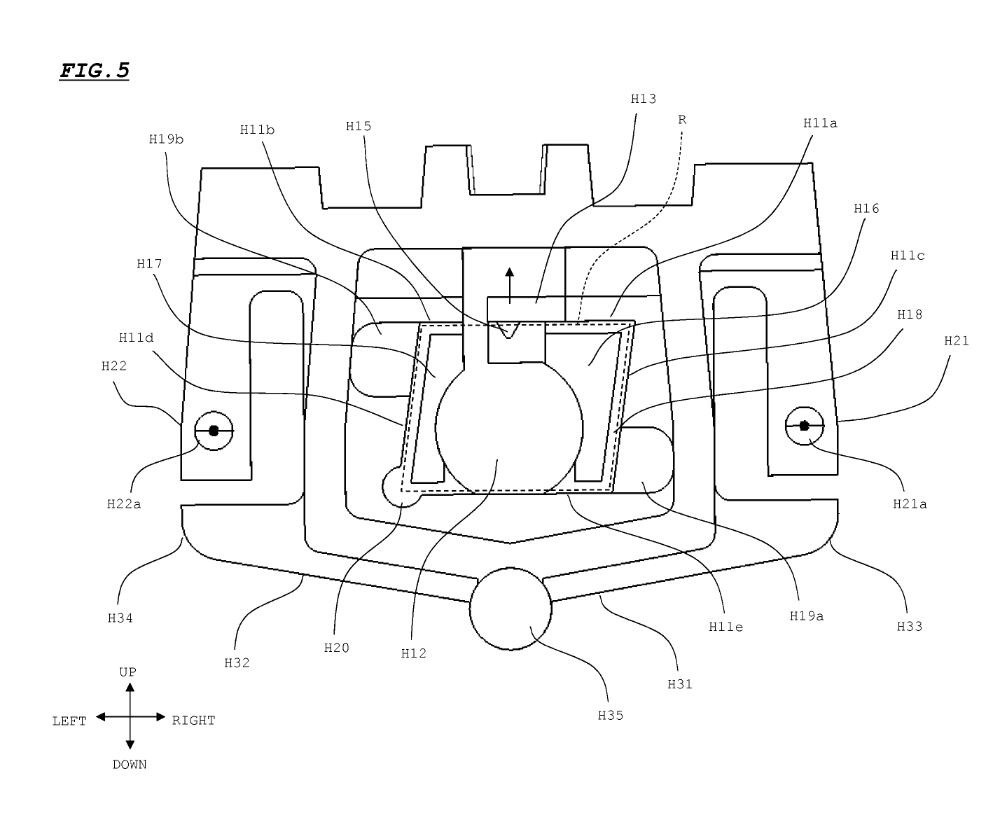

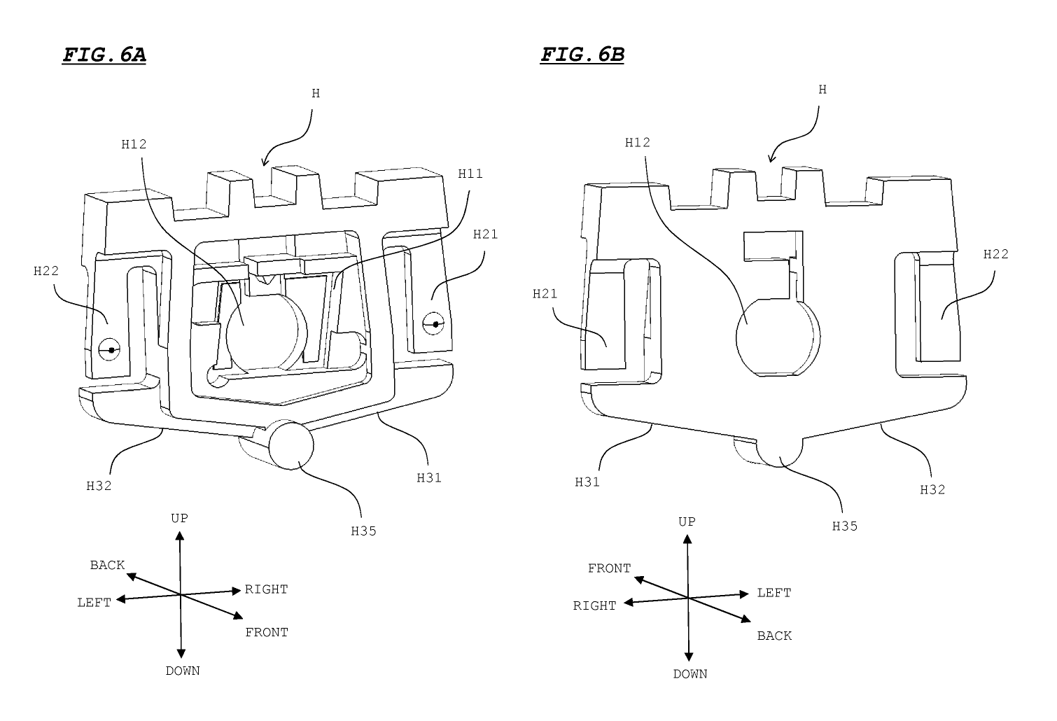

FIGS. 4 to 6B are diagrams showing a configuration of the diffraction grating holder H. FIG. 4 is a perpendicular view of the diffraction grating holder H as seen from the front side, FIG. 5 is a plane view of the diffraction grating holder H as seen from the front side, FIG. 6A is a perpendicular view of the diffraction grating holder H as seen from the front side, and FIG. 6B is a perpendicular view of the diffraction grating holder H as seen from the back side. FIGS. 4 to 6B show up, down, right, left, front, and back directions by arrows orthogonal to each other.

Referring to FIG. 4, the diffraction grating holder H is integrally formed by a flexible material. For example, the diffraction grating holder H is made from a material of glass fibers mixed into polycarbonate. The diffraction grating holder H is bilaterally symmetrical in outer shape. The diffraction grating holder H is formed using a metal mold.

The diffraction grating holder H has at a center thereof walls H11a to H11e for fitting of the diffraction grating 102. As shown in FIG. 2, the walls H11a to H11e are formed so as to define a parallelogram region R slightly larger than the contour of the diffraction grating 102. Formed in the region surrounded by the walls H11a to H11e is an opening H12 for letting BD light, DVD light, and CD light pass through. The walls H11a and H11b are separated from each other in the right-left direction, and a flange part H13 is formed between the walls H11a and H11b so as to extend in the left direction from the wall H11a. The flange part H13 has a back end connected to a plate part H14 extending in the right-left direction.

The flange part H13 has a triangular prism-shaped protrusion part H15 extending in the front-back direction. The protrusion part H15 is connected at a back end to the plate part H14. The protrusion part H15 has a plane part H15a parallel to the front-back and right-left directions. The protrusion part H15 has at a front end thereof an inclined surface H15b stepped back in a downward direction. As shown in FIG. 5, the protrusion part H15 is formed so as to overlap the region R. Since there are gaps at the upper and left sides of the flange part H13, the protrusion part H15 can be displaced upward when the flange part H13 bends upward.

Height of the protrusion part H15 is set such that, when the diffraction grating 102 is fitted as described later, the protrusion part H15 is pressed and escaped by the end edge of the diffraction grating 102. When being pressed and escaped by the end edge of the diffraction grating 102, a leading end of the protrusion part H15 may be slightly crushed.

Formed in the region surrounded by the walls H11a to H11e are support surfaces H16 and H17 parallel to the up-down and right-left directions. The support surfaces H16 and H17 are disposed in the same plane. Specifically, the region surrounded by the walls H11a to H11e has a box shape opened at the front side, and the support surfaces H16 and H17 correspond to a bottom surface of the box shape. When the diffraction grating 102 is attached to the diffraction grating holder H, the support surfaces H16 and H17 support the back surface of the diffraction grating 102. Height of the walls H11a to H11e with reference to the support surfaces H16 and H17 are set to be the same as or slightly smaller than the thickness of the diffraction grating 102. In this arrangement, the height of the walls H11a to H11e with reference to the support surfaces H16 and H17 is set to be slightly smaller than the thickness of the diffraction grating 102, and thus when the back surface of the diffraction grating 102 abuts the support surfaces H16 and H17, the front surface of the diffraction grating 102 slightly protrudes beyond the front ends of the walls H11a to H11e.

Formed in the region surrounded by the walls H11a to H11e is a groove H18 along the contour of the region R as shown in FIG. 5. The groove 18 has a bottom surface stepped backward behind the support surfaces H16 and H17 as shown in FIG. 4. In addition, concave parts H19a and H19b are formed at opposing corners of the region R, and a concave part H20 is formed at a vertex angle sandwiched by these opposing corners. The concave parts H19a and H19b have bottom surfaces positioned in front of the support surfaces H16 and H17, and the concave part H20 has a bottom surface at the same position as the bottom surface of the groove H18 in the front-back direction.

The diffraction grating holder H has arm parts H21 and H22 extending downward in bilaterally symmetrical positions. The arm parts H21 and H22 are bilaterally symmetrical to each other. The arm parts H21 and H22 have front surfaces at the same position in the front-back direction. In addition, the arm parts H21 and H22 have the front surfaces at the same position as lower surfaces Pa and Pb of the diffraction grating holder H in the front-back direction. Formed on the front surfaces of the arm parts H21 and H22 are spherical protrusion parts H21a and H22a, respectively. The protrusion parts H21a and H22a are in symmetrical positions, and the protrusion parts H21a and H22a are the same in protrusion amount.

As shown in FIG. 4, there are gaps (corresponding to “space” recited in the claims) on the left and lower sides of the arm part H21, and the arm part H21 has a front surface hollowed out toward a back surface to make the arm part H21 thinner in the front-back direction, and therefore the arm part H21 can be bent in the front-back direction. Similarly, there are gaps (equivalent to “space” recited in the aims) on the right and lower sides of the arm part H22, and the arm part H22 has a front surface hollowed out toward a back surface to make the arm part H22 thinner in the front-back direction, and therefore the arm part H22 can be bent in the front-back direction.

The diffraction grating holder H has inclined surfaces H31 and H32 at a lower end thereof, and curved surfaces H33 and H34 subsequent to the inclined surfaces H31 and H32. Further, the diffraction grating holder H has a cylindrical support part H35 between the inclined surfaces H31 and H32. The inclined surfaces H31 and H32, the curved surfaces H33 and H34, and the support part H35, are symmetrical with respect to planes parallel to the up-down and front-back directions.

Referring to FIG. 6B, the diffraction grating holder H has the back surface as a plane vertical to the front-back direction. The arms 21 and 22 have the back surfaces at the same position in the front-back direction and in front of the back surface of the diffraction grating holder H.

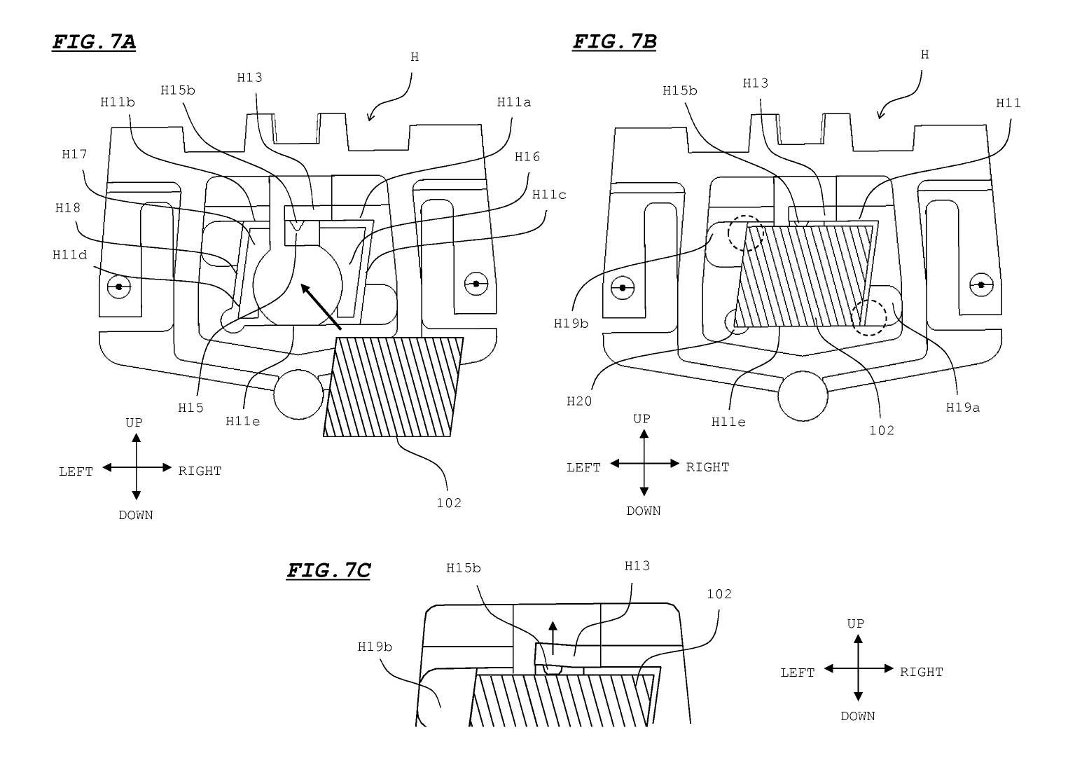

FIGS. 7A to 7C are diagrams for describing a process of attachment of the diffraction grating 102 to the diffraction grating holder H.

As shown in FIG. 7A, the diffraction grating 102 is fitted from the front side in the region surrounded by the walls H11a to H11e. At that time, the diffraction grating 102 is fitted such that the lower surface thereof abuts the wall H11e and the left surface thereof abuts the wall H11d. When the diffraction grating 102 is fitted, an upper edge part of the diffraction grating 102 abuts the inclined surface H15b of the protrusion part H15, as shown in FIG. 7B. In this state, when the diffraction grating 102 is further pressed, the flange part H13 bends upward and the protrusion part H15 is displaced in the up direction (in the direction of an arrow), as shown in FIG. 7C. Accordingly, the lower end of the protrusion part H15 runs on the upper surface of the diffraction grating 102.

After that, the diffraction grating 102 is further pressed until the back surface of the diffraction grating 102 abuts properly the entire support surfaces H16 and H17. In this state, the left surface of the diffraction grating 102 is pressed again against the wall H11d so as to abut the wall H11d. When the diffraction grating 102 is fitted in the region surrounded by the walls H11a to H11e, the leading end of the protrusion part H15b is slightly crushed by the upper surface of the diffraction grating 102 as shown in FIG. 7C.

When the diffraction grating 102 is attached to the diffraction grating holder H, the diffraction grating 102 is subjected to a downward force by a return force of the flange part H13. The lower surface of the diffraction grating 102 is pressed against the wall H11e by this force, whereby the diffraction grating 102 is positioned with respect to the diffraction grating holder H in the up-down and right-left directions. After that, an adhesive agent is flown into a boundary between the concave part H19a and the right surface of the diffraction grating 102 (at a position shown by a dotted-line circle in FIG. 7B) and a boundary between the concave part H19b and the left surface of the diffraction grating 102 (at a position shown by a dotted-line circle in FIG. 7B), to adhere the diffraction grating 102 to the diffraction grating holder H. Accordingly, the attachment of the diffraction grating 102 to the diffraction grating holder H is completed, thereby to form an optical element unit to which the diffraction grating 102 is attached to the diffraction grating holder H.

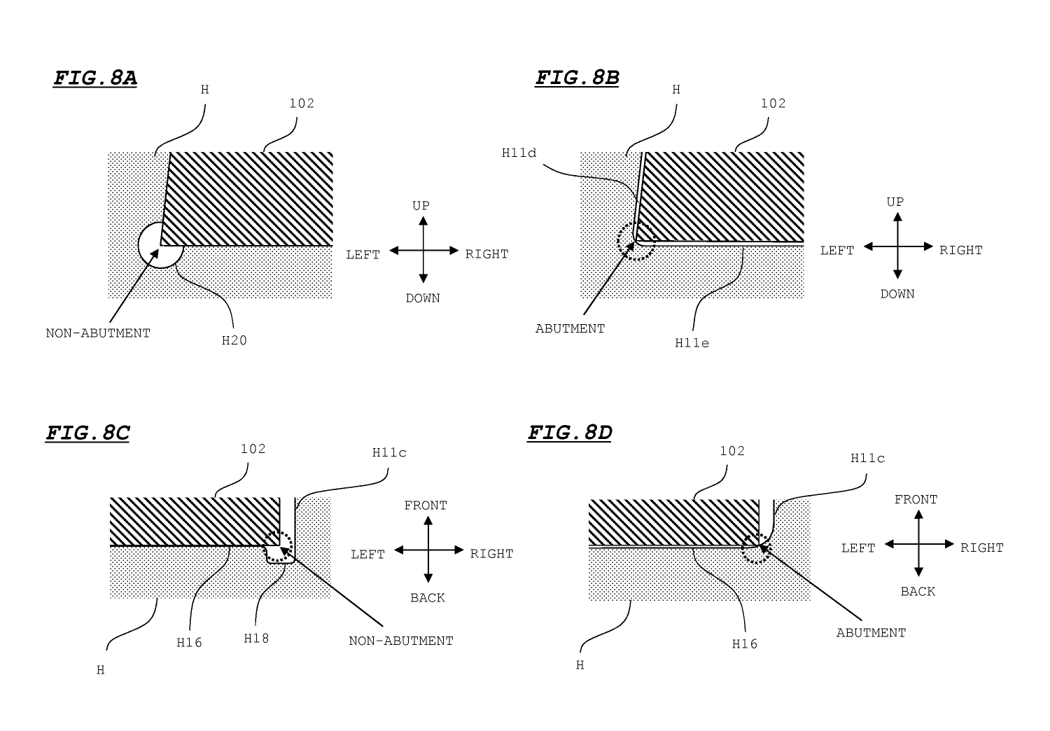

FIG. 8A is a diagram showing an operation of the concave part H20 at attachment of the diffraction grating 102 to the diffraction grating holder H. FIG. 8A shows a lower right corner of the diffraction grating 102. FIG. 8B is a diagram showing a comparative example without forming the concave part H20.

If the concave part H20 is not formed as in the comparative example of FIG. 8B, the boundary between the walls H11d and H11e forms not an acute angle but a curved surface due to blunting at formation of the diffraction grating holder H (that is, processing accuracy of a metal mold). Therefore, a lower left corner of the diffraction grating 102 abuts the curved surface, thereby to produce a gap between the diffraction grating 102 and the walls H11d and H11e at the lower left corner of the diffraction grating 102. As a result, the diffraction grating 102 slightly turns in an in-plane direction, which makes it impossible to place the diffraction grating 102 in a proper attachment position. If, in the state of FIG. 8B, an attempt is made to abut the lower and left surfaces of the diffraction grating 102 with the walls H11d and H11e, the lower left corner of the diffraction grating 102 may be chipped off.

On the other hand, if the concave part H20 is formed as shown in FIG. 8A, the lower left corner of the diffraction grating 102 is escaped into the concave part H20. Therefore, even if there occurs any blunting at formation of the diffraction grating holder H, the lower left corner of the diffraction grating 102 does not abut the diffraction grating holder H. Accordingly, it is possible to arrange the lower and left surfaces of the diffraction grating 102 along the walls H11d and H11e without any gap, which allows the diffraction grating 102 to be placed in a proper attachment position.

FIG. 8C is a diagram showing an operation of the groove H18 at attachment of the diffraction grating 102 to the diffraction grating holder H. FIG. 8C shows a corner at a right back end of the diffraction grating 102. FIG. 8D is a diagram showing a comparative example without the groove H18.

If the groove H18 is not formed as in the comparative example of FIG. 8D, the boundary between the support surface H16 and the wall H11e forms not an acute angle but a curved surface due to blunting at formation of the diffraction grating holder H. Therefore, the corner at the right back end of the diffraction grating 102 abuts the curved surface, thereby to produce a gap between the diffraction grating 102 and the support surface H16 at the corner at the right back end of the diffraction grating 102. As a result, the diffraction grating 102 slightly turns in the front-back direction, which makes it impossible to place the diffraction grating 102 in a proper attachment position.

On the other hand, if the groove H18 is formed as shown in FIG. 8C, there is produced a gap between the corner at the right back end of the diffraction grating 102 and the groove H18. Therefore, even if there occurs any blunting at formation of the diffraction grating holder H, the corner at the right back end of the diffraction grating 102 does not abut the diffraction grating holder H. Accordingly, it is possible to arrange the back surface of the diffraction grating 102 along the support surface H16 without any gap, which allows the diffraction grating 102 to be placed in a proper attachment position. In the foregoing, the operation of the right part of the groove H18 formed along the region surrounded by the walls H11a to H11e, is described. However, the same operation as described above can be achieved at the upper, left, and lower parts of the groove H18.

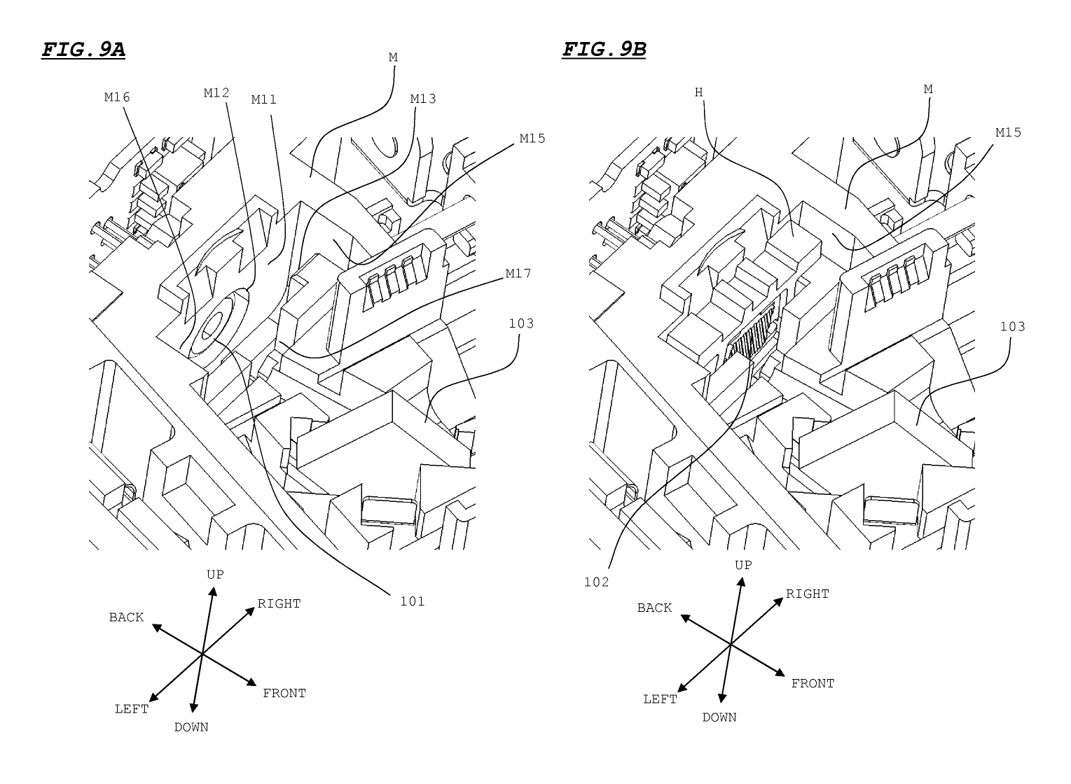

FIG. 9 is a diagram showing a part of the housing M to which the diffraction grating holder H is attached. FIG. 9A is a diagram showing the state of the housing M before attachment of the diffraction grating holder H, and FIG. 9B is a diagram showing the state of the housing M after attachment of the diffraction grating holder H.

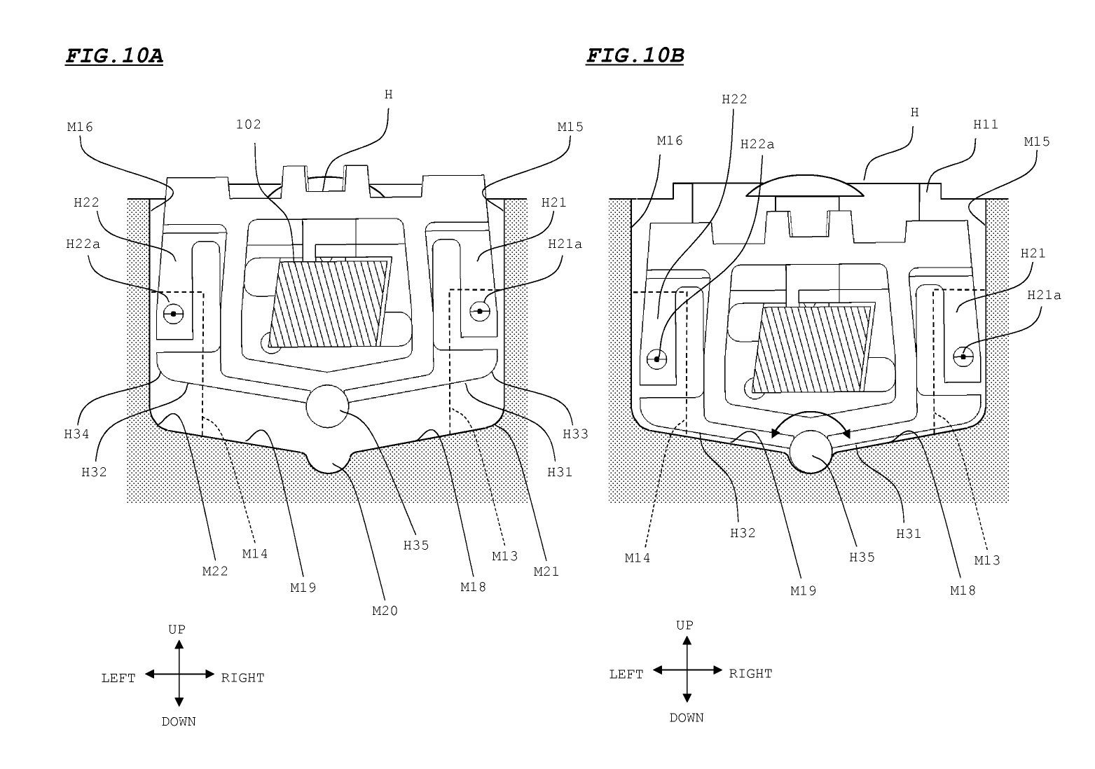

Referring to FIG. 9A, the housing M has a support surface M11 against which the back surface of the diffraction grating holder H is pressed. The support surface M11 has an opening M12 to let light from the semiconductor laser 101 pass through. Further, the housing M has two abutment surfaces M13 and M14 parallel to the support surface M11 (the abutment surface M14 is not shown in FIG. 9A. Reference is made to FIGS. 10A and 10B). The abutment surfaces M13 and M14 are placed in the same position in the front-back direction.

A gap between the support surface M11 and the abutment surfaces M13 and M14 are made slightly larger than a distance between the surfaces Pa and Pb and the back surface of the diffraction grating holder H (thickness of the lower part of the diffraction grating holder H) shown in FIG. 4. In addition, the housing M has walls M15 and M16 opposed to each other in the right-left direction, and has a notch M17 for letting light transmitted from the diffraction grating 102 pass through. The diffraction grating holder H is inserted between the support surface M11 and the abutment surfaces M13 and M14 until reaching a position shown in FIG. 9B.

FIGS. 10A and 10B are diagrams for describing a process of mounting of the diffraction grating holder H to the housing M. FIGS. 10A and 10B are perpendicular views of a mounting part of the diffraction grating holder H as seen through from the front side. FIG. 10A shows the state before the diffraction grating holder H is completely inserted between the support surface M11 and the abutment surfaces M13 and M14, and FIG. 10B shows the state after the diffraction grating holder H is completely inserted between the support surface M11 and the abutment surfaces M13 and M14.

As shown in FIG. 10A, the housing M. has inclined surfaces M18 and M19, a cylindrical concave part M20 extending in the front-back direction, and curved surfaces M21 and M22 at boundaries between the inclined surfaces M18 and M19 and the walls M15 and M16, respectively. In this arrangement, the concave part M20 has a shape similar to that of an outer peripheral surface of the support part H35. That is, since the support part H35 is cylindrically shaped, the concave part M20 is concaved in the shape of a cylindrical surface so as to abut side surfaces of the support part H35.

When the diffraction grating holder H is inserted between the support surface M11 and the abutment surfaces M13 and M14, the protrusion parts H21a and H22a formed at the arm parts H21 and H22 of the diffraction grating holder H abut upper ends of the abutment surfaces M13 and M14, respectively. In this state, when the diffraction grating holder H is further inserted, the arm parts H21 and H22 bend backward, and the protrusion parts H21a and H22a run on the abutment surfaces M13 and M14, respectively, as shown in FIG. 10A. After that, when the diffraction grating holder H is further inserted, the support part H35 fits into the concave part M20, as shown in FIG. 10B. Accordingly, the insertion of the diffraction grating holder H is completed.

In the state of FIG. 10B, the back surface of the diffraction grating holder H is pressed against the support surface M11 of the housing M by a return force of the arm parts H21 and H22. Accordingly, the diffraction grating holder H is positioned in the front-back direction. In addition, when the support part H35 fits into the concave part M20, the diffraction grating holder H is positioned in the right-left direction.

In the state of FIG. 10B, there are gaps between the right and left side surfaces of the diffraction grating holder H and the walls M16 and M15, and there are also gaps between the inclined surfaces H31 and H32 of the diffraction grating holder H and the inclined surfaces M18 and M19 of the housing M. Accordingly, the diffraction grating holder H is rotatable in the in-plane direction around the support part H35.

In the state of FIG. 10B, laser light is emitted from the semiconductor laser 101, and a position of rotation of the diffraction grating holder H (diffraction grating 102) around the support part H35 is adjusted. At that time, since the back surface of the diffraction grating holder H is appropriately pressed against the support surface M11 of the housing M by a return force of the arm parts H21 and H22 to generate a friction force, it is possible to finely adjust the position of rotation of the diffraction grating holder H around the support part H35 in a smooth manner. The force of pressing the back surface of the diffraction grating holder H against the support surface M11 of the housing M is regulated by adjusting thickness of the arm parts H21 and H22. In such a manner, when the position of rotation is completely adjusted, the diffraction grating holder H and the housing M are attached together, and the diffraction grating holder H is fixed to the housing M. Accordingly, the mounting of the diffraction grating 102 to the housing M is completed.

### Advantages of the Embodiment

According to the embodiment, it is possible to produce the following advantages.

When the diffraction grating 102 is fitted into the walls H11a to H11e while the lower surface of the diffraction grating 102 abuts the inner surface of the wall H11e opposed to the protrusion part 15, the diffraction grating 102 can be held in the diffraction grating holder H. At that time, the flange part H13 deforms, and the lower surface of the diffraction grating 102 is pressed against the wall H11e by a return force of the flange part H13. Accordingly, a position gap of the diffraction grating 102 is suppressed, and the diffraction grating 102 is positioned with respect to the diffraction grating holder H. In this state, when an adhesive agent is applied between the diffraction grating 102 and the diffraction grating holder H, the diffraction grating 102 is fixed to the diffraction grating holder H. As in the foregoing, according to the embodiment, the diffraction grating 102 can be attached to the diffraction grating holder H in an easy and proper manner.

Since the protrusion part H15 has the shape of a triangular prism extending in the front-back direction, the protrusion part H15 presses the diffraction grating 102 in a wide area of the diffraction grating 102 in a thickness direction. This allows the diffraction grating 102 to be stably pressed against the wall H11e.

Since the front end of the protrusion part H15 constitutes the inclined surface H15b, when the diffraction grating 102 is fitted, the protrusion part H15 is prone to run on the side surface of the diffraction grating 102, which facilitates attachment of the diffraction grating 102.

Since the groove H18 is formed along the contour of the region R, even if the boundaries between the support surfaces H16 and H17 and the walls H11a to H11e are rounded due to blunting at formation of the holder, it is possible to avoid that the diffraction grating 102 abuts the rounded parts, as described above with reference to FIGS. 8C and 8D. This allows the diffraction grating 102 to be properly attached to the diffraction grating holder H.

Since the concave part H20 is formed at the boundary between the walls H11d and H11e, even if the boundary between the walls H11d and H11e is rounded due to blunting at formation of the holder, it is possible to avoid that the diffraction grating 102 abuts the rounded part, as described above with reference to FIGS. 8A and 8B. This allows the diffraction grating 102 to be properly attached to the diffraction grating holder H.

By adjusting the space provided in the diffraction grating holder H at integral formation, it is possible to elastically displace the protrusion part H15 and elastically deform the arm parts H21 and H22. This realizes a mechanism for holding the diffraction grating 102 and a mechanism for holding the diffraction grating holder H in the housing M by a simple configuration.

After the diffraction grating holder H is mounted in the housing M, the diffraction grating holder H can be swung around the support part H35 to adjust the position of the diffraction grating 102. In addition, at that time, since the back surface of the diffraction grating holder H is pressed against the support surface M11 of the housing M by an elastic return force of the arm parts H21 and H22, the diffraction grating holder H is temporarily fastened at adjustment positions by a friction force between the back surface of the diffraction grating holder H and the support surface M11. This allows the diffraction grating holder H to be smoothly adjusted.

Here, structural features of the diffraction grating 102 and the diffraction grating holder H will be described again as supplements.

The diffraction grating 102 is a hexahedron with a front surface, a back surface, and four side surfaces connecting circumferences of the front and back surfaces. In general, the front and back surfaces of the diffraction grating 102 have each the shape of a rectangle or a parallelogram. In the diffraction grating 102 shown in FIGS. 7A and 7B, of two long sides, the long side facing the protrusion part H15 (upper side) is designated as a first long side, and the lower long side opposed to the first long side is designated as a second long side, and of two short sides, the left short side with the concave part H20 is designated as a first short side, and the right short side opposed to the first short side is designated as a second short side.

The diffraction grating 102 is placed in the diffraction grating holder H having a mounting space shown in FIG. 4. The diffraction grating holder H has a bottom plate with a predetermined thickness from the back surface, and the front surface of the bottom plate constitutes the support surfaces H16 and H17. In addition, the vertically rising abutment walls (walls H11a to H11e) rise with a predetermined thickness from the front surface (support surfaces H16 and H17) of the bottom plate, so as to support the four side surfaces of the diffraction grating 102.

The diffraction grating holder H has the abutment wall for the first short side (wall H11d) and the abutment wall for the second long side (wall H11e), constituting the corner at the position of the concave part H20, and has the abutment wall for the second short side (wall H11c) at the second short side. Further, the diffraction grating holder H has the abutment wall for the first long side (walls H11a and H11b) with the protrusion part H15 inside thereof.

The support surfaces (H16 and H17) are exposed in the diffraction grating placement region surrounded by the four abutment walls, and the opening part (opening H12) is formed by hollowing out the center of the bottom plate.

The abutment wall for the first long side (walls H11a and H11b) is separated into two in the right-left direction, and the separation part reaches the back side of the bottom plate. The abutment wall for the first long side (walls H11a and H11b) is completely separated by the separation part, and the separation part is connected to the opening part (opening H12). The separation part is an L-shaped space. The right abutment wall with the protrusion part H15 (wall H11a) is connected to the abutment wall for the second short side (wall H11c), and extends along the first long side. Alternatively, the protrusion part H15 may be provided on the left abutment wall (wall H11b) connected to the abutment wall for the first short side (wall H11d).

The abutment wall for the first long side with the protrusion part H15 (wall H11a) is completely separated by the foregoing separation part, from the left abutment wall for the first long side (wall H11b) and the left side of the diffraction grating placement region, and constitutes a flexible part with spring-like elasticity. This part can operate like a mechanical switch in which a plate spring is divided and one portion of the spring moves in the up-down direction.

The bottom plate (flange part H13) positioned behind the abutment wall for the first long side with the protrusion part H15 (wall H11a) may be eliminated.

The diffraction grating 102 is attached to the diffraction grating holder H with reference to a surface of the abutment wall for the first short side (wall H11d) and a surface of the abutment wall for the second long side (wall H11e). Therefore, these wall surfaces abut the side surface of the diffraction grating 102 corresponding to the first short side and the side surface of the diffraction grating 102 corresponding to the second long side. The concave part H20 is concaved in a direction away from the corner of the diffraction grating 102, for the reasons that the corner of the diffraction grating 102 has an acute angle and thus is mechanically weak, and the side surfaces of the corner cannot completely abut the reference wall surfaces due to the R part shown in FIG. 8B. Instead of providing the concave part H20, the diffraction grating holder H may be hollowed out at a part corresponding to the concave part H20 so as to penetrate through the back surface. Since the diffraction grating placement region is designed to be slightly larger than the diffraction grating 102 in vertical and horizontal dimensions, there are gaps between the diffraction grating 102 and the abutment wall for the first long side and the abutment wall for the second short side, which facilitates placement of the diffraction grating 102 in the diffraction grating placement region.

Further, since the diffraction grating 102 has also corners on the back surface, the diffraction grating holder H has the escape (groove H18) on the bottom plate (support surfaces H16 and H17). The escape (groove H18) is formed by digging the bottom plate backward from the upper surface (support surfaces H16 and H17), so as to encompass the circumference of the diffraction grating 102 with a width covering the side surface of the diffraction grating 102 from outside to inside. In FIG. 7B, the escape (groove H18) is formed so as to reach from positions immediately below the four abutment walls to the internal side of the diffraction grating 102. Accordingly, the corners on the circumference of the back surface of the diffraction grating 102 do not abut the bottom plate due to the escape (groove H18), thereby preventing the corners from chipping or the like.

In addition, the arm parts (arm parts H21 and H22) extend from the upper side of the bottom plate or the upper side of the abutment wall. The arm parts extend downward from the upper side of the diffraction grating holder H with the protrusion part H15. The left arm part (arm part H22) is designated as a first arm part, and the right arm part (arm part H21) as a second arm part. For example, the first arm part (arm part H22) is provided with an L-shaped separation region on right and lower sides thereof. Since the separation region is formed by hollowing out the diffraction grating holder H from the front to back sides, the first arm part has spring-like elasticity so as to slightly move at least in the front-back direction. The second arm part (arm part H21) is also formed by hollowing out the diffraction grating holder H in an L shape, as with the first arm part (arm part H22), and has elasticity in the front-back direction.

Meanwhile, provided on an outer periphery of the four abutment walls are reinforcement section walls (a section wall for the first long side, a section wall for the second long side, a section wall for the first short side, and a section wall for the second short side) to cover the four sides. Front surfaces of these section walls constitute a foremost surface of the diffraction grating holder H, and the diffraction grating holder H is thickest at the section walls. The front surfaces of the abutment walls are slightly stepped back from the section walls. The first arm part (arm part H22) and the second arm part (arm part H21) are provided integrally with these section walls. Specifically, the first arm part (arm part H22) extends downward from the upper part of the section wall for the first short side so as to sandwich the separation region (gap), and the second arm part (arm part H21) extends downward from the upper part of the section wall for the second short side so as to sandwich the separation region (gap). These arm parts are formed by hollowing out the front sides of the section walls and thus are made thinner. Alternatively, these arm parts may be formed by hollowing out the back sides of the section walls or both the front and back sides of the section walls. The thickness of the arm parts is smaller than the thickness of the diffraction grating holder H between the back surface and the upper surfaces of the section walls (thickness of the thickest part of the diffraction grating holder H), which is ⅓ or more of the thickness of the diffraction grating holder H between the back surface and the upper surfaces of the section walls.

Further, these arm parts have the protrusion parts (protrusion parts H21a and H22a) on top surfaces of the lower parts. The protrusion parts have a spherical shape formed by dividing a ball, but the shape of the protrusion parts is not limited to the one in the embodiment, as with the protrusion part H15.

In addition, provided at a center of the section wall for the second long side is the cylindrical support part (support part H35) with an axis extending in the front-back direction. From the support part H35, thin insertion parts with a difference in level from the section wall for the second long side (parts sandwiched by the surfaces Pa and Pb and the back surface of the diffraction grating holder H) extend to the lower sides of the arm parts (arm parts H21 and H22). The thin insertion plates and the arm parts are formed with the same thickness, or the arm parts are formed so as to be slightly thinner than the insertion plates. Accordingly, as shown in FIG. 9B, when the diffraction grating holder H to which the diffraction grating 102 is attached is inserted between the abutment wall (support surface M11) and the abutment walls (abutment surfaces M13 and M14) opposed to each other on the housing M, the protrusion parts (protrusion parts H21a and H22a) abut the abutment walls (abutment surfaces M13 and M14).

As in the foregoing, the diffraction grating holder H is integrally formed of resin, and thus can be mass-produced by metal molds. In addition, the diffraction grating holder H is configured to have a holding mechanism without using a metallic spring or the like. Specifically, by providing the resin-molded object with separation regions and adjusting thickness of the individual parts, it is possible to make flexible the protrusion parts (protrusion parts H15, H21a, and H22a). The foregoing configuration realizes a mechanism for holding the diffraction grating 102, or a mechanism for holding the diffraction grating holder H in the housing M. In addition, the diffraction grating holder H is an integrated article of resin, which achieves cost reduction and weight saving.

As in the foregoing, the embodiment of the present invention is described. However, the present invention is not limited to the foregoing embodiment, and the embodiment of the present invention can be modified in various manners besides the foregoing ones.

For example, in the foregoing embodiment, the present invention is applied to the holder for the diffraction grating 102. However, the present invention is applicable as appropriate to not only the holder for the diffraction grating 102 but also holders for other optical elements in the optical pickup apparatus, such as the diffraction optical element 109.

In the foregoing embodiment, the contour of the diffraction grating 102 is a parallelogram. However, the shape of the diffraction grating 102 is not limited to the foregoing one but may be any other shape such as a square or a rectangle.

In the foregoing embodiment, the protrusion part H15 has the shape of a triangular prism. However, the shape of the protrusion part H15 is not limited to the foregoing one but may be any other shape such as a square prism, a semicircular cylinder, or a shape formed by cutting a circular cylinder in a longitudinal direction. In addition, the protrusion part H15 may have a protrusion part with a shape formed by partially cutting a ball, as with the protrusion parts H21a and H22a, at least at one place in the front-back direction. In the foregoing embodiment, the protrusion part H15 is formed at the flange part H13 as part of the wall H11a. Alternatively, the protrusion part H15 may protrude from another wall part. The protrusion part H15 may not necessarily formed at a part extended to be flush with the surfaces of the walls H11a to H11e . For example, the protrusion part H15 may be formed at a part stepped back outward from the walls H11a to H11e.

In the foregoing embodiment, the region R is defined by the five walls H11a to H11e . However, the number of the walls defining the region R is not limited to this, but may be six or more with which the wall H11e is separated in the right-left direction, for example.

In the foregoing embodiment, the arm parts H21 and H22 extend approximately straight down. However, the arm parts H21 and H22 may be inclined with respect to the up-down direction. In addition, the arm parts H21 and H22 may not extend in parallel but may be inclined such that ends thereof come closer to the center, for example. In the foregoing embodiment, the arm parts H21 and H22 extend downward, but the arm parts H21 and H22 may extend upward instead. The protrusion parts H21a and H21b formed on the arm parts H21 and H22 can be corrected in shape and position as appropriate.

In the foregoing embodiment, the arm parts H21 and H22 provide a force of pressing the diffraction grating holder H against the support surface M11 of the housing M. However, the means for providing the force may not be necessary spaced at the lower end, unlike the arm parts H21 and H22, but the means is only required to be flexible when the diffraction grating holder H is mounted on the housing M.

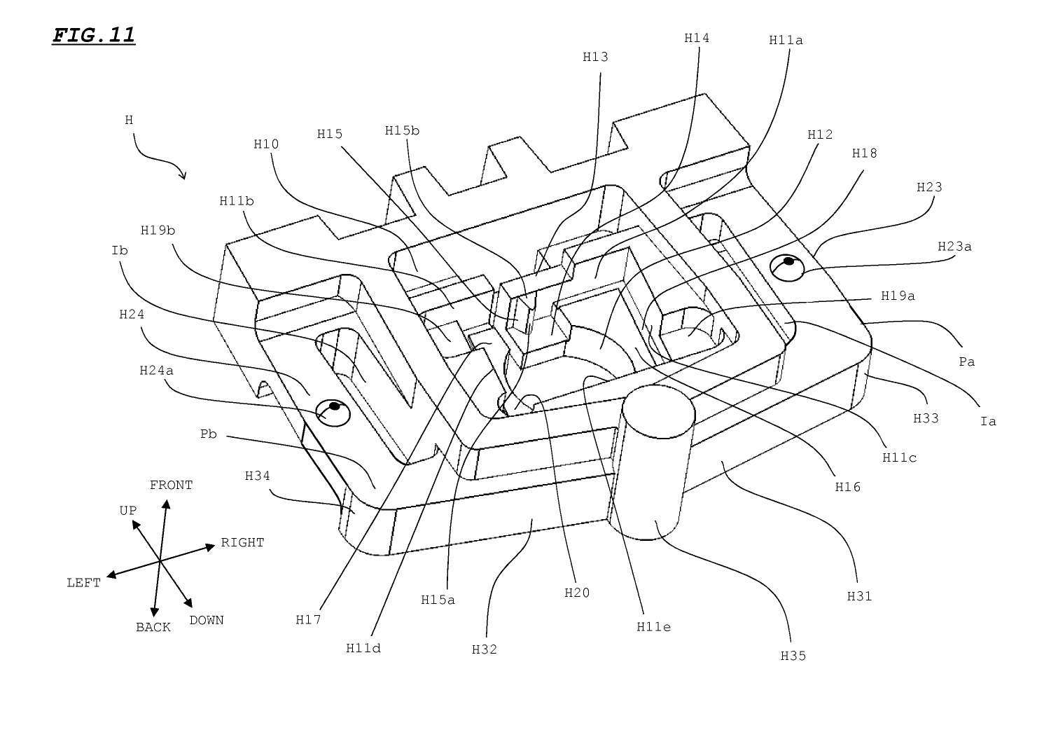

FIG. 11 is a diagram showing a configuration example in which the arm parts H21 and H22 are replaced with other flexible means.

In the configuration example, bridge parts H23 and H24 are provided in place of the arm parts H21 and H22. The bridge parts H23 and H24 are formed by coupling the lower ends of the arm parts H21 and H22 in the foregoing embodiment to the lower part of the diffraction grating holder H. The bridge parts H23 and H24 have vertically extending slit-like spaces (openings) Ia and Ib, respectively, on the center of the diffraction grating holder H. Since the bridge parts H23 and H24 are hollowed out on back surfaces thereof, the bridge parts H23 and H24 have the shape of a plate thinner than neighboring parts thereof. As in the foregoing, the bridge parts H23 and H23 are divided by the spaces Ia and Ib and are made thinner, and thus are flexible in the front-back direction. An elastic force of the bridge parts H23 and H24 in the front-back direction depends on the material for the diffraction grating holder H, the size of the spaces Ia and Ib, and the thickness of the bridge parts H23 and H24. Accordingly, adjusting these factors makes it possible to adjust an elastic return force of the bending bridge parts H23 and H24.

The bridge parts H23 and H24 have the protrusion parts H23a and H24a on front surfaces thereof, as in the foregoing embodiment. The shape of the protrusion parts H23a and H24a is the same as that of the protrusion parts H21a and H22a described in relation to the foregoing embodiment.

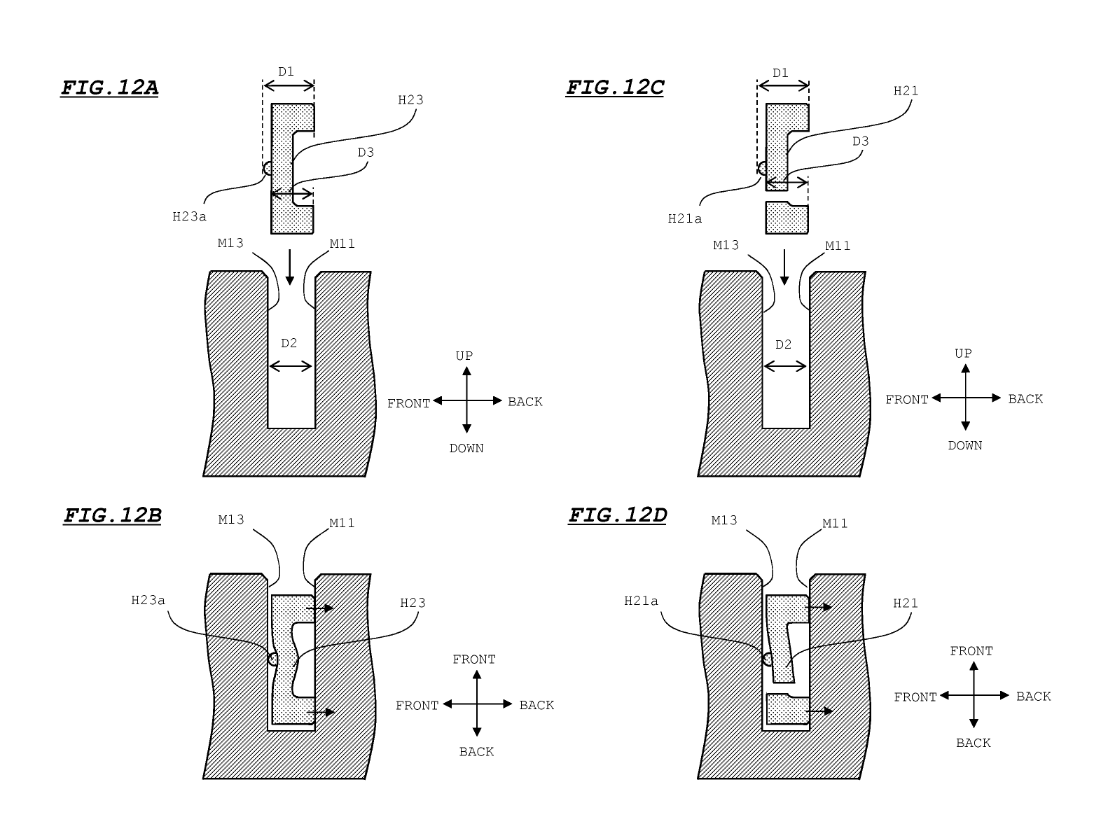

FIGS. 12A and 12B are diagrams schematically showing operations of the bridge parts H23 and H24 at mounting of the diffraction grating holder H configured as shown in FIG. 11 on the housing M. FIGS. 12A and 12B show operations of the bridge part H23, but the bridge part H24 exerts the same operations as described below.

Referring to FIG. 12A, a distance D1 from the back surface of the diffraction grating holder H to the leading end of the protrusion part H23a is larger than a distance D2 from the support surface M11 to the abutment surface M13 of the housing M. In addition, a distance D3 from the back surface of the diffraction grating holder H to the front surface of the bridge part H23 is smaller than the distance D2 from the support surface M11 to the abutment surface M13 of the housing M.

In the state of FIG. 12A, when the diffraction grating holder His inserted into a gap between the support surface M11 and the abutment surface M13, the protrusion part H23a is pressed by the abutment surface M13, and the bridge part H23 bends backward, as shown in FIG. 12B. Then, the diffraction grating holder H is biased backward by an elastic return force of the bridge part H23, and the back surface of the diffraction grating holder H is pressed against the support surface M11. Accordingly, a friction force of a predetermined magnitude is generated between the back surface of the diffraction grating holder H and the support surface M11, thereby to realize smooth position adjustment of the diffraction grating holder H around the support part H35 as described above.

FIGS. 12C and 12D are diagrams schematically showing operations of the arm parts H21 and H22 at mounting of the diffraction grating holder H configured according to the foregoing embodiment on the housing M. FIGS. 12C and 12D show operations of the arm part H21, but the arm part H22 exerts the same operations as described below.

In the foregoing embodiment, the relationships among the distances D1, D2, and D3 are the same as those shown in FIGS. 12A and 12B. Therefore, in the foregoing embodiment, in the state of FIG. 12C, when the diffraction grating holder H is inserted into a gap between the support surface M11 and the abutment surface M13, the protrusion part H23a is pressed by the abutment surface M13, and the arm part H21 bends backward, as shown in FIG. 12D. Then, the diffraction grating holder H is biased backward by an elastic return force of the arm part H21, and the back surface of the diffraction grating holder H is pressed against the support surface M11.

In the foregoing embodiment, the flange part H13 and the protrusion part H15 are used as a configuration for attaching the diffraction grating 102 to the diffraction grating holder H in a smooth and proper manner. However, only from the viewpoint of smoothly attaching the diffraction grating holder H to the housing M, it is just needed that the arm parts H21 and H22 and the protrusion parts H21a and H22a on one side each thereof, and the bridge parts H23 and H24 and the protrusion parts H23a and H24a on one side each thereof, are all formed on the diffraction grating holder H, and therefore the structure for attaching the diffraction grating 102 may be different. For example, the region R may be defined by the walls without the flange part H13 and the protrusion part H15. In this case, the wall H11a and the wall H11b are not separated but integrated. In addition, the peripheral surface of the diffraction grating 102 may not be necessarily regulated by the walls, but may be regulated by protrusions or the like.

In the foregoing embodiment, when the diffraction grating holder H is mounted to the housing M as shown in FIG. 9B, the back surface of the diffraction grating holder H is pressed against the support surface M11 of the housing M, and the back surface of the diffraction grating holder H is supported by the support surface M11. However, the back surface of the diffraction grating holder H may not be necessarily supported by a surface, but may be supported by a plurality of protrusion parts or a protrusion part and a surface.

The number of the arm parts H21 and H22 or the bridge parts H23 and H24 may be not limited to two, but may be one or three or more. However, the arm parts and the ridge parts are desirably arranged such that the diffraction grating holder H is pressed against the support surface M11 as uniformly as possible.

Besides, the structure for mounting the diffraction grating holder H to the housing M, the configuration of an optical system in the optical pickup apparatus, and the like, may be modified as appropriate in various manners. In addition, the present invention is also applicable to holders for optical elements in optical apparatuses other than the optical pickup apparatus.

The embodiment of the present invention can be modified as appropriate in various manners within the scope of the technical ideas recited in the claims.

What is claimed is:

1. A holder for holding an optical element and mounting the same to a placement member, wherein
the holder is made of a flexible material,
the holder has in an integrated manner:
a wall surface that defines a contour of a region in which the optical element is fitted with a predetermined gap;
a protrusion part that protrudes in a direction perpendicular to the wall surface and is formed at a support part so as to be deformable in a direction away from the region; and
a support surface that, when the optical element is fitted in the region, abuts a side surface of the optical element in a fitting direction, and
the protrusion part is formed such that: when the optical element is fitted in the region while the side surface of the optical element abuts the wall surface opposed to the protrusion part, a leading end of the protrusion part abuts an end edge of the optical element, and in the state in which the leading end of the protrusion part abuts the end edge of the optical element, when the optical element is further pressed in the fitting direction, the support part elastically deforms and the protrusion part abuts the side surface of the optical element beyond the end edge of the optical element, the side surface of the optical element in the fitting direction abuts the support surface, and then the optical element is pressed against the wall surface by an elastic return force of the support part.

2. The holder for an optical element according to claim 1, wherein
the protrusion part has a columnar shape extending in a fitting direction of the optical element.

3. The holder for an optical element according to claim 2, wherein
a side surface of the protrusion part abutted by the end edge of the optical element when the optical element is fitted in the region, is inclined so as to gradually come closer to the support surface with increasing proximity to an internal side of the region.

4. The holder for an optical element according to claim 1, wherein
a groove part is formed along an outer periphery of the region so as to be stepped back in the fitting direction behind the support surface.

5. The holder for an optical element according to claim 1, wherein
the optical element has a contour of a square,
the holder has the wall surfaces corresponding to four sides of the square,
the protrusion part is formed so as to overlap one side of the square region defined by the wall surfaces, and
the optical element is fitted in an internal side of the wall surfaces by being pressed onto a first wall surface defining a first side of the square region opposed to the side overlapped by the protrusion part and a second wall surface defining a second side adjacent to the first side.

6. The holder for an optical element according to claim 5, wherein
an escape part is formed at a boundary between the first side and the second side to avoid abutment between a corner of the optical element and the holder.

7. The holder for an optical element according to claim 5, wherein
the wall surface defining the side of the square region overlapped by the protrusion part is separated into a third wall surface and a fourth wall surface, the protrusion part is formed on the third wall surface, a space for separating the third wall surface and the fourth wall surface is provided so as to communicate from between the third wall surface and the fourth wall surface to a region on an opposite side of the protrusion part with respect to the third wall surface, thereby to form the support part between the third wall surface and the space.

8. The holder for an optical element according to claim 1, further comprising:
first and second plate-like flexible parts that are formed at positions sandwiching the region and are defined by space so as to be flexible in the fitting direction; and
first and second protrusion parts that are formed on one each surface of the first and second flexible parts and abut an abutment surface of the placement member when the holder is mounted to the placement member, wherein
when the holder is mounted to the placement member, the first and second protrusion parts abut the abutment surface to elastically deform the first and second flexible parts, and a side surface of the holder is pressed against a holding part of the placement member by an elastic return force of the deformed first and second flexible parts.

9. The holder for an optical element according to claim 8, further comprising
a circular cylindrical support axis part that, when the holder is mounted to the placement member, is placed on a reception part of the placement member and has a central axis made parallel to the fitting direction, wherein
when the holder is mounted to the placement member, the support axis part is placed on the reception part, and the holder is held by the placement member so as to be swingable around the support axis part.

10. An optical element unit, comprising:
a holder holding an optical element; and
an optical element attached to the holder, wherein
the holder is made of a flexible material,
the holder has in an integrated manner:
a wall surface that defines a contour of a region in which the optical element is fitted with a predetermined gap;
a protrusion part that protrudes in a direction perpendicular to the wall surface and is formed at a support part so as to be deformable in a direction away from the region; and
a support surface that, when the optical element is fitted in the region, abuts a side surface of the optical element in a fitting direction, and
the protrusion part is formed such that: when the optical element is fitted in the region while the side surface of the optical element abuts the wall surface opposed to the protrusion part, a leading end of the protrusion part abuts an end edge of the optical element, and in the state in which the leading end of the protrusion part abuts the end edge of the optical element, when the optical element is further pressed in the fitting direction, the support part elastically deforms and the protrusion part abuts the side surface of the optical element beyond the end edge of the optical element, the side surface of the optical element in the fitting direction abuts the support surface, and then the optical element is pressed against the wall surface by an elastic return force of the support part.

11. An optical pickup apparatus, comprising:
an optical system for radiating laser light emitted from a laser light source to a disc;
a housing as the placement member on which the optical system is placed; and
a holder mounted on the housing in a state of holding a predetermined optical element constituting the optical system, wherein
the holder is made of a flexible material,
the holder has in an integrated manner:
a wall surface that defines a contour of a region in which the optical element is fitted with a predetermined gap;
a protrusion part that protrudes in a direction perpendicular to the wall surface and is formed at a support part so as to be deformable in a direction away from the region; and
a support surface that, when the optical element is fitted in the region, abuts a side surface of the optical element in a fitting direction, and
the protrusion part is formed such that: when the optical element is fitted in the region while the side surface of the optical element abuts the wall surface opposed to the protrusion part, a leading end of the protrusion part abuts an end edge of the optical element, and in the state in which the leading end of the protrusion part abuts the end edge of the optical element, when the optical element is further pressed in the fitting direction, the support part elastically deforms and the protrusion part abuts the side surface of the optical element beyond the end edge of the optical element, the side surface of the optical element in the fitting direction abuts the support surface, and then the optical element is pressed against the wall surface by an elastic return force of the support part .

12. A holder for holding an optical element and mounting the same to a placement member, wherein
the holder is made of a flexible material,
the holder has in an integrated manner:
a holding part holding the optical element;
a plate-like flexible part defined by space so as to be made flexible; and
a protrusion part that is formed on one surface of the flexible part and abuts an abutment surface of the placement member when the holder is mounted to the placement member, wherein
when the holder is mounted to the placement member, the protrusion part abuts the abutment surface to elastically deform the flexible part, and a side surface of the holder is pressed against a holding part of the placement member by an elastic return force of the deformed flexible part.

13. The holder according to claim 12, wherein
the flexible part is a thin-walled part made thinner than neighboring parts thereof.

14. The holder according to claim 12, wherein
the space is provided in a slit-like shape between the holding part and the flexible part.

15. The holder according to claim 12, wherein
the flexible part has a shape of an arm extending in one direction.

16. The holder according to claim 12, wherein
the flexible part is provided in symmetrical positions with the holding part therebetween, and
the protrusion part is formed on a surface of the holding part oriented in the same direction.

17. The holder according to claim 12, wherein
the protrusion part becomes gradually smaller with increasing proximity to a protruding direction.

18. The holder for an optical element according to claim 12, further comprising:
a circular cylindrical support axis part that, when the holder is mounted to the placement member, is placed on a reception part of the placement member and has a central axis made parallel to the fitting direction, wherein
when the holder is mounted to the placement member, the support axis part is placed on the reception part, and the holder is held by the placement member so as to be swingable around the support axis part.
